(19) United States
(12) Patent Application Publication
(10) Pub. No.: US 2021/0070642 A1
(43) Pub. Date: Mar. 11, 2021

(54) Ballasted Activated Sludge Treatment Combined with High-Rate Liquids/Solids Separation Systems

(71) Applicant: Carollo Engineers, Inc., Costa Mesa, CA (US)

(72) Inventor: John Fraser, Arvada, CO (US)

(21) Appl. No.: 16/642,567

(22) PCT Filed: Aug. 29, 2018
(86) PCT No.: PCT/US2018/048528

§ 371 Date: Feb. 27, 2020

Related U.S. Application Data
(60) Provisional application No. 62/553,393, filed on Sep. 1, 2017.

(51) Int. Cl. C02F 3/12; C02F 3/30

(52) U.S. Cl. CPC C02F 3/1226; C02F 3/308; C02F 2305/12; C02F 3/1215; C02F 3/307

(57) ABSTRACT

Described is a method of treating wastewater. The method includes receiving the wastewater at a ballasted activated sludge secondary treatment aeration basin. The method also includes adding a ballast material to the wastewater, treating the wastewater in the ballasted activated sludge secondary treatment aeration basin to produce a ballasted mixed liquor effluent, receiving the ballasted mixed liquor effluent at a high-rate heavy solids removal zone that includes one or more high-rate heavy solids removal units, and removing ballasted heavy solids from the ballasted mixed liquor effluent using the one or more high-rate heavy solids removal units to produce a concentrated ballasted heavy solids effluent and a clarified liquid effluent. Also described is a system for treating wastewater including a ballasted activated sludge secondary treatment aeration basin and a high-rate heavy solids removal zone for treating a ballasted mixed liquor effluent.

### CROSS-REFERENCE TO RELATED APPLICATION

This application claims priority to United States Provisional Patent Application No. 62/553,393, entitled “Ballasted Activated Sludge Treatment Combined with High-rate Liquid/Solids Separation Systems,” filed Sep. 1, 2017, the entire contents of which are herein incorporated by reference.

### BACKGROUND

### Field

This disclosure relates to activated sludge wastewater treatment systems. More particularly, this disclosure relates to high-rate heavy solids separation techniques in ballasted activated sludge (BAS) systems.

### Description of Related Art

In wastewater treatment, the activated sludge process is a type of secondary wastewater or excess flow (or wet weather) treatment process to achieve reduction of pollutants using a suspended or mixed (attached and suspended) culture of biologically active biomass to convert pollutants into cell mass that is subsequently separated from the liquid phase through a liquid/solids separation process. Currently available activated sludge processes include those that use conventional secondary clarifiers and those that use barrier-based liquid/solids separation to separate the solid phase from the liquid phase. Non-limiting examples of conventional activated sludge wastewater treatment processes include those described in U.S. Pat. No. 4,537,682 to Wong-Chong and U.S. Pat. No. 4,961,854 to Wittmann et al., the entire contents of both of which are incorporated herein by reference.

Conventional secondary clarifiers include circular or rectangular clarification units intended for gravity settling of typical mixed liquor from an activated sludge secondary wastewater or excess flow treatment process. These clarifiers are generally designed at average overflow rates from 400 to 800 gpd/sf (gallons per day per square foot of clarifier area) and/or average solids loading rates from 20 to 40 ppd/sf (pounds per day per square foot of clarifier area). FIG. 1A represents a non-limiting example of a process flow schematic for liquid/solids separation in an activated sludge system using a conventional secondary clarifier. In this embodiment, an influent wastewater source 1000 enters an activated sludge aeration basin unit 1010 having an anaerobic selector zone 1020 and an aerobic activated sludge zone 1030. The conventional secondary clarifier unit 1040 includes return activated sludge (RAS) to the aeration basin 1050 and produces a clarified effluent 1060. Non-limiting examples of conventional secondary clarifiers include those described in U.S. Pat. No. 7,637,379 to Pophali et al. and U.S. Pat. No. 4,383,922 to Beard, the entire contents of both of which are incorporated herein by reference

Barrier-based liquid/solids separation includes those processes downstream of or within an activated sludge process that create a physical barrier to separate solids from the liquid phase. These include, but are not limited to, membrane bio reactor (MBR) or other effluent filtration or barrier solids separation processes. Effluent filtration can be used to further clean clarified effluent and typically involves removal of additional solids from the clarified effluent from activated sludge after passing through conventional secondary clarifiers. This could include sand filters, multimedia filters, deep bed filters, cloth filters, continuous backwash filters, synthetic media filters, and the like. FIG. 1B represents a process flow schematic for liquid/solids separation in an activated sludge system using barrier-based liquid/solids separation unit 1070.

### SUMMARY

Described is a system and process for the treatment of wastewater. The system uses high-rate heavy solids removal techniques for clarification, settling, and solids separation of a ballasted activated sludge (BAS) process mixed liquor. The high-rate heavy solids removal process can, for example, be incorporated into the BAS aeration basin or placed in an external basin configuration downstream of the BAS aeration basin.

Various aspects of the present disclosure may be further characterized by one or more of the following clauses:

Clause 1: A method of treating wastewater that includes: receiving the wastewater at a ballasted activated sludge secondary treatment aeration basin, wherein the ballasted activated sludge secondary treatment aeration basin comprises one or more zones for biomass growth; adding a ballast material to the wastewater; treating the wastewater in the ballasted activated sludge secondary treatment aeration basin to produce a ballasted mixed liquor effluent; receiving the ballasted mixed liquor effluent at a high-rate heavy solids removal zone that includes one or more high-rate heavy solids removal units; and removing ballasted heavy solids from the ballasted mixed liquor effluent using the one or more high-rate heavy solids removal units to produce a concentrated ballasted heavy solids effluent and a clarified liquid effluent.

Clause 2: The method of Clause 1, wherein the one or more high-rate heavy solids removal units are selected from an aerated grit removal unit, a vortex-type grit removal unit, a stacked-tray type grit removal unit, a cyclone type grit removal unit, or combinations thereof.

Clause 3: The method of Clause 1, wherein at least one of the one or more high-rate heavy solids removal units is a stacked-tray grit removal unit.

Clause 4: The method of any of Clauses 1-3, wherein at least a portion of the concentrated ballasted heavy solids effluent is returned to the ballasted activated sludge secondary treatment aeration basin.

Clause 5: The method of any of Clauses 1-4, further including treating the clarified liquid effluent in an effluent filtration unit, barrier separation unit, or a tertiary treatment process.

Clause 6: The method of Clause 5, wherein the tertiary treatment process includes a disinfection process, a high-rate clarification process, a direct filtration process, or any combination thereof.

Clause 7: The method of any of Clauses 1-6, wherein the ballast material includes a natural ballast material.

Clause 8: The method of Clause 7, wherein the natural ballast material is selected from activated sludge granules, anammox granules, grit particles, struvite, vivianite, other precipitates, and combinations thereof.

Clause 9: The method of any of Clauses 1-8, wherein the ballast material includes an artificial ballast material.

Clause 10: The method of Clause 9, wherein the artificial ballast material is selected from sand, iron, iron derivatives, synthetic fabricated materials and shapes, and combinations thereof.

Clause 11: The method of any of Clauses 1-10, wherein the ballast material includes a mixture of one or more natural ballast materials and one or more artificial ballast materials.

Clause 12: The method of any of Clauses 1-11, wherein the ballasted activated sludge secondary treatment aeration basin includes a first zone operating under anaerobic conditions, a second zone operating under anoxic conditions, a third zone operating under aerobic conditions, a fourth zone operated under anoxic conditions, and a fifth zone adapted to re-aerate the wastewater contained therein.

Clause 13: The method of any of Clauses 1-12, further including reducing phosphorus in the ballasted mixed liquor effluent through the addition of iron salts or polymers to the ballasted mixed liquor effluent to facilitate precipitation of phosphorus from the ballasted mixed liquor effluent.

Clause 14: A system for treating wastewater that includes: a ballasted activated sludge secondary treatment aeration basin adapted to receive a wastewater influent, wherein the ballasted activated sludge secondary treatment aeration basin includes one or more zones for biomass growth, and wherein the wastewater is treated in the ballasted activated sludge secondary treatment aeration basin to generate a ballasted mixed liquor effluent; a ballast material addition unit adapted to add the ballast material to the wastewater; and a high-rate heavy solids removal zone adapted to receive the ballasted mixed liquor effluent, wherein the high-rate heavy solids removal zone includes one or more high-rate heavy solids removal units adapted to remove ballasted heavy solids from the ballasted mixed liquor effluent and produce a concentrated ballasted heavy solids effluent and a clarified liquid effluent.

Clause 15: The system of Clause 14, wherein the one or more high-rate heavy solids removal units are selected from an aerated grit removal unit, a vortex-type grit removal unit, a stacked-tray type grit removal unit, a cyclone type grit removal unit, or combinations thereof.

Clause 16: The method of any of Clauses 14-15, wherein at least one of the one or more high-rate heavy solids removal units is a stacked tray grit removal unit.

Clause 17: The method of any of Clauses 14-16, further including an effluent filtration or tertiary treatment unit in communication with the high-rate heavy solids removal zone, wherein the effluent filtration or tertiary treatment unit is adapted to treat the clarified liquid effluent.

Clause 18: The method of Clause 17, wherein the tertiary treatment unit is adapted to include a disinfection process, a high-rate clarification process, a direct filtration process, or any combination thereof.

Clause 19: The method of any of Clauses 14-18, wherein the ballasted activated sludge secondary treatment aeration basin includes a first zone operating under anaerobic conditions, a second zone operating under anoxic conditions, a third zone operating under aerobic conditions, a fourth zone operated under anoxic conditions and a fifth zone adapted to re-aerate the wastewater contained therein.

Clause 20: The system of any of Clauses 14-19, further including a plurality of the ballasted activated sludge secondary treatment aeration basins and a plurality of the high-rate heavy solids removal zones, wherein each of the plurality of the ballasted activated sludge secondary treatment aeration basins has one of the high-rate heavy solids removal zone associated therewith.

### BRIEF DESCRIPTION OF THE DRAWINGS

FIGS. 1A and 1B are exemplary process flow schematics generally representing currently available liquid/solids separation systems;

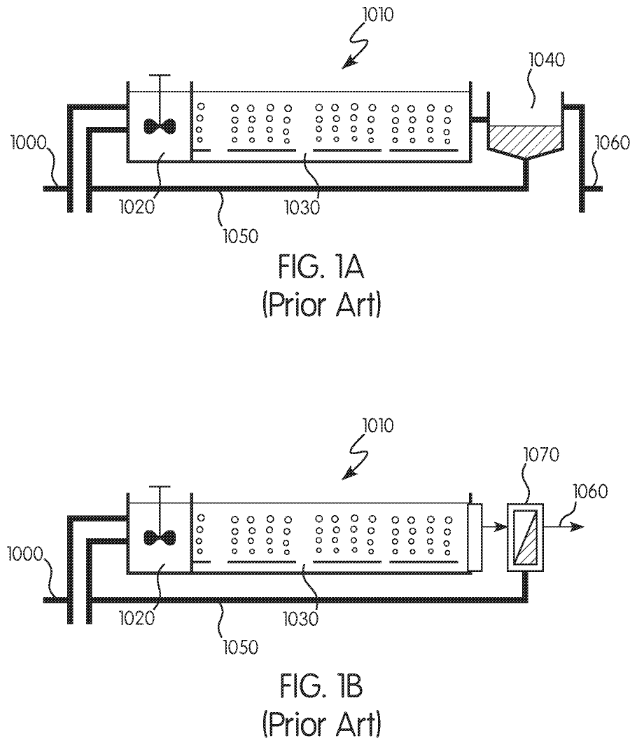

FIG. 2 is a process flow schematic of a wastewater treatment system according to one embodiment of this disclosure;

FIG. 3 is a schematic of a wastewater treatment system according to another embodiment of this disclosure; and

FIG. 4 provides a graph of data generated during a test of a wastewater treatment system according to this disclosure.

### DETAILED DESCRIPTION

For purposes of the description hereinafter, spatial orientation terms shall relate to the embodiment as it is oriented in the drawing figures. However, it is to be understood that the various embodiments of this disclosure may assume alternative variations and step sequences, except where expressly specified to the contrary. It is also to be understood that the specific devices and processes illustrated in the attached drawings, and described in the following specification, are simply exemplary. Hence, specific dimensions and other physical characteristics related to the embodiments disclosed herein are not to be considered as limiting.

As used in the specification, the singular form of “a”, “an”, and “the” include plural referents unless the context clearly dictates otherwise.

Unless otherwise indicated, all ranges or ratios disclosed herein are to be understood to encompass any and all subranges or sub-ratios subsumed therein. For example, a stated range or ratio of “1 to 10” should be considered to include any and all subranges between (and inclusive of) the minimum value of 1 and the maximum value of 10; that is, all subranges or subratios beginning with a minimum value of 1 or more and ending with a maximum value of 10 or less, such as but not limited to, 1 to 6.1, 3.5 to 7.8, and 5.5 to 10.

All documents, such as but not limited to issued patents and patent applications, referred to herein, and unless otherwise indicated, are to be considered to be “incorporated by reference” in their entirety.

For purposes of this disclosure the following definitions apply:

Activated Sludge—Secondary wastewater treatment or excess flow treatment processes based on reduction of wastewater pollutants including nutrients using a suspended culture of biologically active biomass to convert pollutant into cell mass that is subsequently separated from the liquid phase through a liquids/solids separation process.

Artificial Ballast—Any ballast material added to the mixed liquor that does not occur naturally in the wastewater. Non-limiting examples include sand, iron or iron derivatives, synthetic fabricated shapes, etc.

Ballast Material—Material that is generated in or added to mixed liquor with the expressed purpose or side benefit of improved solids separation and settling.

Ballasted Activated Sludge (BAS) Process—Any of a number of secondary wastewater treatment or excess flow peak flow treatment systems that use natural or artificial ballast to aid in settling and solids separation.

Barrier Based Liquid/Solids Separation—Any process downstream of any activated sludge system that creates a physical barrier to separate solids from the liquid phase, including but not limited to membrane bio reactor (MBR) and other barrier-based effluent filtration processes.

Conventional Secondary Clarifiers—Clarification units intended for gravity settling of typical mixed liquor from an activated sludge secondary treatment or excess flow treatment process (CAS, BNR, etc). Conventional secondary clarifiers are generally designed at average overflow rates from 400 to 800 gpd/sf and/or average solids loading rates from 20 to 40 ppd/sf and are generally designed as circular or rectangular in shape, or a combination of both.

Effluent Filtration—Filtration for additional solids removal of effluent from activated sludge after going through conventional secondary clarifiers. This includes activated sludge or ballasted activated sludge aeration basin effluent from either high-rate clarification (HRC) or high-rate heavy solids removal systems. Non-limiting examples include sand filters, multimedia filters, deep bed filters, cloth filters, continuous backwash filters, and synthetic media filters, etc.

Excess Flow or Wet Weather Flow Treatment—Any process that is intended to treat or partially treat high flows in excess of normal daily peaks for discharge under wet weather or stormflow conditions.

Floc Shear Process—Any process intended to dislodge or shear biological floc from ballast material. Non-limiting examples include air bubble curtains, high shear mixing, shear mills, overflow weirs or other agitators, etc.

HIBASS—High-rate Ballasted Activated Sludge System. The system may either be placed within a BAS process or external from and following a BAS process.

High-rate Clarification (HRC)—Process intended to provide high-rate liquid/solids separation when compared to gravity settling in larger secondary clarifiers. Non-limiting examples include tube settlers, plate settlers, sand ballasted clarification, iron or iron derivative ballasted clarification, sludge blanket reactors, etc.

High-rate Heavy Solids Removal—Processes normally associated with preliminary treatment intended to remove heavy material from raw wastewater including sand and grit. Non-limiting examples include aerated grit removal units, vortex type grit removal units, stacked tray type grit removal units, cyclone type grit removal units, etc.

Liquid/Solids Separation Process—Any method of gravity or physical barrier intended to allow separation of a suspended solid from the liquid phase.

Natural Ballast—Any naturally occurring ballast material within the wastewater or generated in the process of liquid or solids treatment applied to the mixed liquor to aid in treatment and settling. Non-limiting examples include activated sludge granules, anammox granules, grit particles, struvite/vivianite, or other precipitates formed in solids handling systems, etc.

High-rate heavy solids separation processes are well established for removal of high specific gravity particles (such as sand and grit) from raw wastewater and are commonly used for influent wastewater grit removal in preliminary treatment. The nature, size, shape, and specific gravity of the particle dictates the selection of the most effective high-rate heavy solids separation technique.

Separately, ballasted activated sludge (BAS) processes are gaining favor in the wastewater treatment industry due to their ability to provide rapid liquid/solids separation and settling, allow operation at higher mixed liquor concentrations, and reduce the aeration basin footprint and capital cost required for treatment. A wide variety of new BAS processes are in development and anticipated to be developed in the future. Current BAS processes use conventional secondary clarifiers or high rate clarification.

The subject disclosure relates to a system and process that uses high-rate heavy solids removal techniques, typically applied in preliminary treatment for sand and grit removal, for the clarification, settling, and solids separation of a BAS process mixed liquor. The system may be part of a BAS process or external to, such as subsequent to, a BAS process.

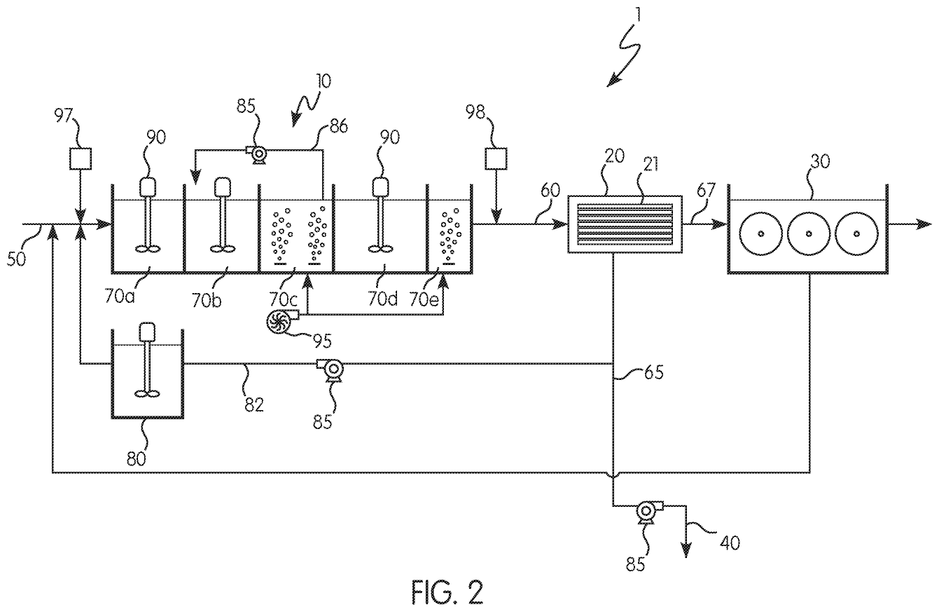

FIG. 2 presents one embodiment of a system 1 in which BAS treatment is combined with high-rate heavy solids removal. However, variations in this configuration can be achieved consistent with the general principles described herein. For example, this disclosure applies to other BAS configurations and other high-rate heavy solids separation processes as well.

With reference to FIG. 2, a wastewater influent 50, which may have been subject to a primary treatment such as sedimentation to reduce the amount of suspended solids and the biochemical oxygen demand (BOD), is biologically treated in a BAS secondary treatment aeration basin 10 so as to generate a ballasted biological mixed liquor 60. While resident in the BAS secondary treatment aeration basin 10, biomass cultured in the secondary treatment aeration basin 10 consume and reduce the amount of BOD, ammonia, nitrogen, phosphorus, and/or other pollutants in the wastewater. The BAS process can be in the form of one or more of a secondary wastewater treatment aeration basin or excess flow treatment system aeration basin that uses natural and/or artificial ballast materials to aid in settling and solids separation. Excess flow treatment includes those processes that are intended to treat or partially treat high flows in excess of normal daily peaks, such as wet weather flows that occur under wet weather or stormflow conditions.

In one embodiment, the BAS secondary treatment aeration basin 10 can include a series of zones, such as anaerobic, anoxic, and/or aerobic zones and/or return activated sludge (RAS) conditioning. In one embodiment, depicted in FIG. 2, the BAS secondary treatment aeration basin 10 includes zones 70a-e, including an anaerobic zone 70a, a first anoxic zone 70b, an aerobic zone 70c, a second anoxic zone 70d, and a reaeration zone 70e, along with RAS conditioning through the use of an anoxic or anaerobic RAS conditioning zone 80. In this embodiment, the first zone 70a is an anaerobic zone configured to operate under anaerobic conditions for phosphorus reduction or biomass selection, the second zone 70b is an anoxic zone configured to operate under anoxic conditions for nitrogen reduction or biomass selection, the third zone 70c is an aerobic zone configured to operate under aerobic conditions for BOD, ammonia, or other pollutant reduction, the fourth zone 70d is a second anoxic zone configured to operate under anoxic conditions for further nitrogen reduction, and the fifth zone 70e is a reaeration zone which is configured to re-aerate the wastewater to remove final trace biochemical oxygen demand (BOD) or ammonia contained therein. The RAS conditioning zone 80 is configured to operate under anoxic or anaerobic conditions to support improved nitrogen reduction or enhanced biological phosphorus removal (EBPR). The above-described configuration constitutes a non-limiting embodiment, and it is envisioned that the BAS secondary treatment aeration basin 10 can include other numbers, types, and arrangements of zones. For example, the BAS secondary treatment aeration basin 10 may alternatively include two, three, four, six, seven, or more zones, of which one or more are anaerobic zones, one or more are anoxic zones, one or more are aerobic zones, and one or more are reaeration zones. By way of example only, the BAS secondary treatment aeration basin 10 may be comprised of two zones, the first of which is an anaerobic or anoxic zone and the second of which is an aerobic zone. The number, type, and arrangement of zones is dictated by the biomass to be cultured and the particular pollutants which are targeted for removal, as would be appreciated by one of skill in the art upon reading the present disclosure.

One or more blowers or other oxygen sources 95 can be arranged so as to provide oxygen into any one or more of the aerobic and/or reaeration zones. One or more of the zones can also be outfitted with a mixer, such as a propeller mixer, diffuser mixer, large bubble mixer, or other mixing device 90. One or more pumps 85 can be provided to transfer the wastewater solids or mixed liquor between the clarifiers, high-rate heavy solids separation units, to or between zones, or to solids wasting. One or more supplemental carbon sources can be added to the wastewater at various points in or external to the BAS secondary treatment aeration basin 10 to enhance phosphorus and nitrogen reduction, such as through supplemental carbon source feed unit 97 positioned to supply supplemental carbon to the wastewater influent 50 prior to it reaching the BAS secondary treatment aeration basin 10. As depicted in FIG. 2, an internal recycle (IR) stream 86 can recycle wastewater from the aerobic zone 70c to, for example, an anoxic zone 70b for purposes of nitrogen reduction.

The wastewater can be treated with a ballast material at various points in the BAS secondary treatment aeration basin 10. For purposes of this disclosure, a ballast material is any material that is generated in or added to mixed liquor for the purpose of improving liquids/solids separation and settling. The ballast material can be, for example, an artificial ballast, which is a ballast material added to the mixed liquor that does not occur naturally in wastewater, such as but not limited to sand, iron or iron derivatives, or synthetic fabricated materials and shapes, etc. The ballast material may also be a natural ballast, which is a naturally occurring ballast material within the wastewater or generated in the process of liquid or solid treatment applied to the mixed liquor to aid in liquids/solids separation and settling. Naturally-occurring ballast materials include, but are not limited to, activated sludge granules, anammox granules, grit particles, struvite/vivianite, and other precipitates formed in solids handling systems, etc. The ballast material can also include combinations of natural and artificial ballasts. In one non-limiting embodiment, the ballast material includes magnetite, such as is described in United States Patent Application Publication No. 2015/0210574, the entire contents of which are incorporated by reference. The type of ballast material (natural or artificial) will dictate which high-rate heavy solids processes will be most effective in liquid/solids separation and settling.

Ballast material can be added to the wastewater stream influent 50. The ballast material can also, or alternatively, be added to the wastewater in any of the zones 70a-e of BAS secondary treatment aeration basin 10 directly through a ballast material supply unit (in the form of, e.g., a ballast supply tank in combination with a metering pump) that is in communication with one or more of the zones. Ballast material can also, or alternatively, be added to the RAS, the IR, or other locations that flow to the zones 70a-e in amounts prescribed by the particular type of ballast being used. In some non-limiting embodiments, the amount of ballast material added should be sufficient to provide a mass ratio of ballast material to mixed liquor in the ballasted mixed liquor effluent 60 of approximately 0.25:1 to 1.75:1, such as 0.5:1 to 1.5:1, or 0.7:1 to 1:1. Make-up ballast is often added to account for minor amounts of ballast loss that occurs in the process. Ballast material is often separated from the liquids and recovered or discarded, such as through a floc shear process and ballast material recovery.

The system 1 may function under a chemical phosphorus reduction mode (Chem P) through the addition of chemicals to, for example, the ballasted mixed liquor effluent 60 in the BAS secondary treatment aeration basin 10. Chemicals added can be, for example, iron salts or polymers, which are added in appropriate quantities to support chemical precipitation of phosphorus. These chemicals can be added to the mixed liquor from, for example, a Chem P addition unit 98.

Upon exiting the BAS secondary treatment aeration basin 10, the ballasted mixed liquor effluent 60 is passed through one or more high-rate heavy solids removal units 21 located in a high-rate heavy solids removal zone 20 for removal of heavy solids. The high-rate heavy solids removal process is of the type that is currently known to be used for preliminary treatment to remove heavy material from raw, untreated wastewater, including sand and grit. Potentially useful embodiments of the high-rate heavy solids removal unit 21 include, but are not limited to, aerated grit removal units, vortex type grit removal units (e.g., a hydrodynamic separator comprising a cylindrical vessel), stacked tray type grit removal units (e.g., a stacked tray separator comprising stacked settling plates), and cyclone type removal units. Examples of potentially useful high-rate heavy solids removal units includes those described in U.S. Pat. No. 8,342,338 to Andoh et al., U.S. Pat. No. 6,730,222 to Andoh et al., U.S. Pat. No. 6,645,382 to Wilson, U.S. Pat. No. 5,061,375 to Oyler, U.S. Pat. No. 4,767,532 to Weis, and U.S. Pat. No. 3,941,698 to Weis, the entire contents of each of which are herein incorporated by reference. High-rate heavy solids removal zone 20 may include any number of high-rate heavy solids removal units 21, the particular number of which may depend on the volume of ballasted mixed liquor effluent 60 and/or amount of material to be removed therefrom, and the high-rate heavy solids removal units 21 located in a particular high-rate heavy solids removal zone 20 may each be of the same type or may be of different types, the particular selection of which may depend on the particular application and materials to be removed. In the non-limiting embodiment of FIG. 2, a single high-rate heavy solids removal unit 21 in the form of a stacked tray type grit removal unit is shown in high-rate heavy solids removal zone 20. Once removed, the heavy solids effluent 65 can be returned to the BAS secondary treatment aeration basin 10 directly or through the RAS conditioning zone 80 and/or pumped out as waste activated sludge (WAS) stream 40 for recovery or further solids treatment and disposal.

A clarified liquid effluent 67, which may contain remaining light solids floc, is discharged from the high-rate heavy solids removal zone 20 for either direct discharge to a receiving water or for further downstream treatment by a tertiary treatment zone 30. This downstream treatment can include, for example, disinfection, high-rate clarification, direct filtration, advanced water treatment (AWT) or a combination of tertiary treatment processes. By way of further explanation, high-rate clarification refers to a process intended to provide high-rate liquid/solids separation when compared to gravity settling in larger secondary clarifiers, including tube settlers, plate settlers, sand ballasted clarification, iron or iron derivative ballasted clarification, sludge blanket reactors, and the like. Effluent filtration can also be used to treat the effluent from either a high-rate clarification or high-rate heavy solids system.

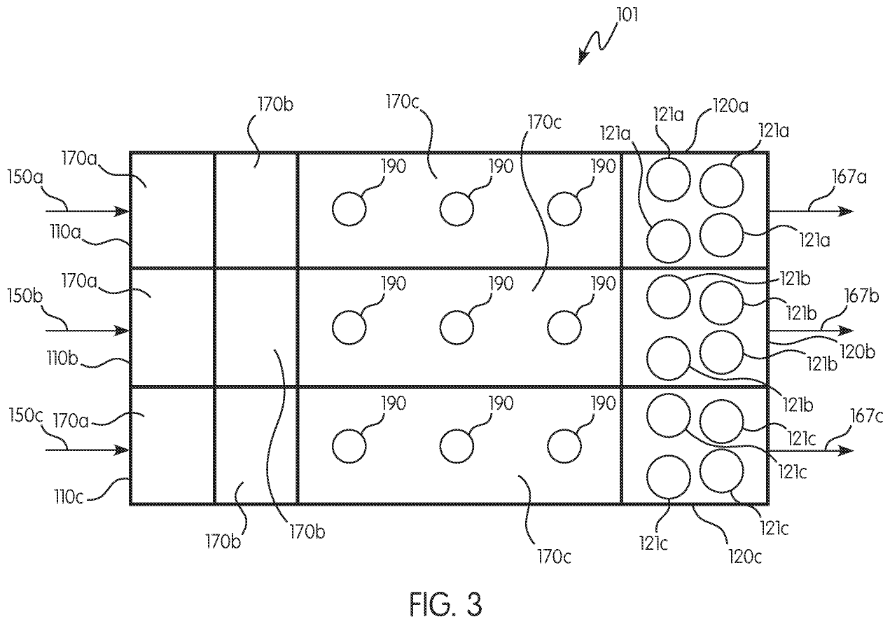

FIG. 3 presents another embodiment of a system 101 in which BAS treatment of influent wastewater 150a-c is combined with high-rate heavy solids removal. In this embodiment, system 101 includes multiple (e.g., three parallel) BAS secondary treatment aeration basins 110a-c. Each BAS secondary treatment aeration basin 110a-c includes two anaerobic zones 170a-b and a larger aerobic zone 170c including one or more aerators or aeration diffusers/mixers 190. However, this configuration of zones is non-limiting and each BAS secondary treatment aeration basin 110a-c may be comprised of different numbers and/or types of zones. In addition, the zoning of one BAS secondary treatment aeration basins, e.g., 110a, may differ from the zoning of one or more of the other BAS secondary treatment aeration basin, e.g., 110b and/or 110c. Each of the BAS secondary treatment aeration basins 110a-c is paired with a high-rate heavy solids removal zone 120a-c, each including one or more high-rate heavy solids removal units 121a-c. Clarified liquid effluents 167a-c from the high-rate heavy solids removal zones 120a-c can each be discharged to a receiving water or further treated in downstream processes. In FIG. 3, each of high-rate heavy solids removal zones 120a-c is depicted as including a set of multiple (e.g., four) high-rate heavy solids removal units 121a-c in the form of stacked tray units, though this is exemplary only and each high-rate heavy solids removal zone 120a-c may include a different number and/or type of high-rate heavy solids removal units 121a-c for the reasons described above. Moreover, the high-rate heavy solids removal unit(s), e.g., 121a associated with one BAS secondary treatment aeration basin, e.g., 110a, may differ in form or type from the high-rate heavy solids removal unit(s), e.g., 121b, 121c associated with one or more of the other BAS secondary treatment aeration basins, e.g., 110b and/or 110c.

Also described is a process of treating wastewater using the system described above. In a first step of the process, wastewater (which may have been subject to primary treatment) is biologically treated in a BAS secondary treatment aeration basin. In a second step, biological mixed liquor containing ballast material exiting the BAS secondary treatment aeration basin is introduced into a high-rate heavy solids removal zone having one or more high-rate heavy solids removal units. In the high-rate heavy solids removal zone, heavy solids are removed from the ballasted mixed liquor to produce a concentrated heavy solids effluent and a clarified liquid effluent with, potentially, some amount of light solids floc. The concentrated heavy solids effluent can be returned to the BAS secondary treatment aeration basin. In a third step, the clarified liquid effluent discharged from the high-rate heavy solids removal zone can be directly discharged or subject to downstream tertiary treatment, such as disinfection, high-rate clarification, filtration or any combination of tertiary treatment processes.

The system and process described herein can provide many advantages. For one, the system and process allow for the elimination of conventional secondary clarifiers when using certain BAS processes. The elimination of conventional secondary clarifiers may result in significant capital and operation and maintenance cost savings. The elimination of conventional secondary clarifiers may also significantly reduce the site space and process footprint required for secondary treatment, thus allowing for more compact (or intensified) treatment facilities in areas where land is unavailable or at a premium cost.

### Examples

Certain benefits and advantages of the systems and processes described herein will now be further explained with reference to the following non-limiting examples.

One embodiment of HIBASS was tested to determine proof of concept, performance potential, and loading rate characteristics. Two phases of testing were conducted. All testing was performed with bench scale and pilot scale equipment at the Upper Gwynedd Township Waste Water Treatment Plant in Upper Gwynedd Township, Pennsylvania, USA.

Phase I—Phase I proof of concept testing was conducted using a bench scale stacked tray grit removal unit. The bench scale stacked tray (high-rate heavy solids removal) unit included four, 1-ft diameter stacked trays enclosed in a stainless steel housing with influent, effluent, and underflow piping connections and pumps, as necessary. Magnetite ballasted activated sludge mixed liquor at 8,000 to 10,000 mg/L mixed liquor suspended solids (MLSS) was fed to the test unit at varying flow rates. The bench scale test unit was able to achieve an effluent total suspended solids (TSS) value of between 200 and 300 mg/L at surface overflow rates (SOR) of approximately 1,000 to 1,500 gpd/sf of equivalent tray surface area and solids loading rates (SLR) of approximately 90 to 175 ppd/sf. As stated above, conventional secondary clarifiers used for liquids/solids separation in activated sludge secondary wastewater treatment are generally designed at surface overflow rates (SOR) of 400 to 800 gpd/sf and/or solids loading rates (SLR) of 20 to 40 ppd/sf. Phase I test results indicated that the stacked tray, high-rate heavy solids removal process provided 96% to 98% TSS removal at approximately two to three times higher liquid and solids loading rates when compared to conventional activated sludge with conventional clarification. It was concluded that the performance of this embodiment of the HIBASS process had the potential to provide significant improvement over currently established technology and would result in both cost savings and reduced facility footprint.

Phase II—Phase II loading and performance testing was conducted using a larger pilot scale stacked tray grit removal unit. The pilot scale stacked tray (high-rate heavy solids removal) unit included three, 4-ft diameter stacked trays enclosed in a stainless steel housing with influent, effluent, and underflow piping connections, meters, and pumps, as necessary. Magnetite ballasted activated sludge mixed liquor at 8,000 to 10,000 mg/L MLSS was fed to the test unit at varying flow rates. Test runs were conducted over several hours at five feed flow rates, or surface overflow rates (SOR), as follows: ˜1,000 gpd/sf, ˜1,200 gpd/sf, ˜1,400 gpd/sf, ˜1,600 d/sf, and ˜1,800 gpd/sf. At each of the above cited feed flow rates, the underflow rates were varied to achieve a range of solids loading rates (SLR) expressed as ppd/sf. Solids loading rates were varied until failure occurred, which was defined as an effluent TSS of approximately 1,000 mg/L or higher. Data from the Phase II test runs is presented in Table 1.

TABLE 1
Summary of Phase II Test Results

| | | | Effluent TSS | Effluent TSS | Effluent TSS | Effluent TSS |
|---|---|---|---|---|---|---|
| | | Effluent TSS | (mg/L) at | (mg/L) at | (mg/L) at | (mg/L) at |
| | Actual | (mg/L) at | SLR of | SLR of | SLR of | SLR of |
| | SOR | SLR of | 106-119 | 128-133 | 151-172 | 199-239 |
| Test # | (gpd/sf) | 93-96 ppd/sf | ppd/sf | ppd/sf | ppd/sf | ppd/sf |
| 1 | 1,010 | 17.5 | 19.6 | 21.0 | 31.3 | 49.1 |
| 2 | 1,193 | — | 41.0 | — | 82.0 | 1262.0 |
| 3 | 1,392 | 59.0 | — | 51.0 | 50.0 | 898.0 |
| 4 | 1,631 | — | 48.0 | 60.0 | 150.0 | 1600.0 |
| 5 | 1,800 | — | 40.0 | 80.0 | 1200.0 | failure |

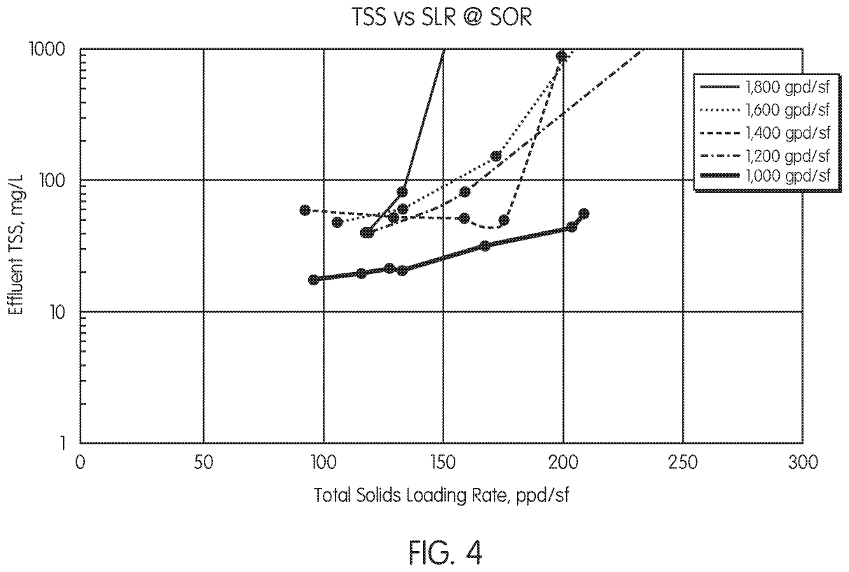

Data from the Phase II testing has been plotted in FIG. 4. FIG. 4 illustrates that the Phase II testing demonstrates the ability to produce effluent TSS of 60 mg/L or less when operating at feed flow rates (SOR) of 1,000 gpd/sf to 1,800 d/sf and solids loading rates (SLR) from <100 ppd/sf to ˜175 ppd/sf. Phase II testing indicated the general relationship that higher solids loading rates can be achieved at lower flow loading rates and conversely that higher flow loading rates can be achieved at lower solids loading rates while maintaining effluent TSS below 60 mg/L.

Phase II testing concluded that the larger pilot scale test unit resulted in significantly lower effluent TSS at 99.2% to 99.8% TSS removal at approximately two to three times higher liquid and solids loading rates when compared to conventional activated sludge with conventional clarification. Effluent TSS quality is comparable to conventional secondary clarifiers. It was concluded that the HIBASS process could provide significant improvement over currently established technology and additionally result in both cost savings and reduced facility footprint.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements. For example, it is to be understood that the present invention contemplates that, to the extent possible, one or more features of any embodiment can be combined with one or more features of any other embodiment.

1. A method of treating wastewater, comprising:
receiving the wastewater at a ballasted activated sludge secondary treatment aeration basin, wherein the ballasted activated sludge secondary treatment aeration basin comprises one or more zones for biomass growth;
adding a ballast material to the wastewater;
treating the wastewater in the ballasted activated sludge secondary treatment aeration basin to produce a ballasted mixed liquor effluent;
receiving the ballasted mixed liquor effluent at a high-rate heavy solids removal zone that includes one or more high-rate heavy solids removal units; and
removing ballasted heavy solids from the ballasted mixed liquor effluent using the one or more high-rate heavy solids removal units to produce a concentrated ballasted heavy solids effluent and a clarified liquid effluent.

2. The method of claim 1, wherein the one or more high-rate heavy solids removal units are selected from the group consisting of: an aerated grit removal unit, a vortex-type grit removal unit, a stacked-tray type grit removal unit, a cyclone type grit removal unit, and combinations thereof.

3. The method of claim 1, wherein at least one of the one or more high-rate heavy solids removal units is a stacked-tray grit removal unit.

4. The method of claim 1, wherein at least a portion of the concentrated ballasted heavy solids effluent is returned to the ballasted activated sludge secondary treatment aeration basin.

5. The method of claim 1, further comprising treating the clarified liquid effluent in an effluent filtration unit, barrier separation unit, or a tertiary treatment process.

6. The method of claim 5, wherein the tertiary treatment process comprises a disinfection process, a high-rate clarification process, a direct filtration process, or any combination thereof.

7. The method of claim 1, wherein the ballast material includes a natural ballast.

8. The method of claim 7, wherein the natural ballast is selected from the group consisting of: activated sludge granules, anammox granules, grit particles, struvite, vivianite, or other precipitates, and combinations thereof.

9. The method of claim 1, wherein the ballast material includes an artificial ballast.

10. The method of claim 9, wherein the artificial ballast is selected from the group consisting of: sand, iron, iron derivatives, synthetic fabricated materials and shapes, and combinations thereof.

11. The method of claim 1, wherein the ballast material includes a mixture of one or more natural ballasts and one or more artificial ballasts.

12. The method of claim 1, wherein the ballasted activated sludge secondary treatment aeration basin includes a first zone operating under anaerobic conditions, a second zone operating under anoxic conditions, a third zone operating under aerobic conditions, a fourth zone operated under anoxic conditions, and a fifth zone adapted to re-aerate the wastewater contained therein.

13. The method of claim 1, further comprising reducing phosphorus in the ballasted mixed liquor effluent through the addition of iron salts or polymers to the ballasted mixed liquor effluent to facilitate precipitation of phosphorus from the ballasted mixed liquor effluent.

14. A system for treating wastewater, comprising:
a ballasted activated sludge secondary treatment aeration basin adapted to receive a wastewater influent, wherein the ballasted activated sludge secondary treatment aeration basin includes one or more zones for biomass growth, and wherein the wastewater is treated in the ballasted activated sludge secondary treatment aeration basin to generate a ballasted mixed liquor effluent;
a ballast material addition unit adapted to add the ballast material to the wastewater; and
a high-rate heavy solids removal zone adapted to receive the ballasted mixed liquor effluent, wherein the high-rate heavy solids removal zone includes one or more high-rate heavy solids removal units adapted to remove ballasted heavy solids from the ballasted mixed liquor effluent and produce a concentrated ballasted heavy solids effluent and a clarified liquid effluent.

15. The system of claim 14, wherein the one or more high-rate heavy solids removal units are selected from the group consisting of: an aerated grit removal unit, a vortex-type grit removal unit, a stacked-tray type grit removal unit, a cyclone type grit removal unit, and combinations thereof.

16. The system of claim 14, wherein at least one of the one or more high-rate heavy solids removal units is a stacked tray grit removal unit.

17. The system of claim 14, further comprising an effluent filtration or tertiary treatment unit in communication with the high-rate heavy solids removal zone, wherein the effluent filtration or tertiary treatment unit is adapted to treat the clarified liquid effluent.

18. The system of claim 17, wherein the tertiary treatment unit is adapted to include a disinfection process, a high-rate clarification process, a direct filtration process, or any combination thereof.

19. The system of claim 14, wherein the ballasted activated sludge secondary treatment aeration basin includes a first zone operating under anaerobic conditions, a second zone operating under anoxic conditions, a third zone operating under aerobic conditions, a fourth zone operated under anoxic conditions and a fifth zone adapted to re-aerate the wastewater contained therein.

20. The system of claim 14, further comprising a plurality of the ballasted activated sludge secondary treatment aeration basins and a plurality of the high-rate heavy solids removal zones, wherein each of the plurality of the ballasted activated sludge secondary treatment aeration basins has one of the high-rate heavy solids removal zone associated therewith.
